(19) United States
(12) Patent Application Publication
(10) Pub. No.: US 2025/0001696 A1
(43) Pub. Date: Jan. 2, 2025

(54) IMPLEMENTING TEMPERATURE CHANGE DURING A 4D PRINTING PROCESS

(71) Applicant: International Business Machines Corporation, Armonk, NY (US)

(72) Inventors: Luis Alberto DEL RIO URIBE, Tlajomulco de Zuniga (MX); Rogelio Cuevas DELGADILLO, San Pedro Tlaquepaque (MX); Carolina GARCIA DELGADO, Zapopan (MX); Jeremy R. FOX, Georgetown, TX (US)

(21) Appl. No.: 18/346,193

(22) Filed: Jun. 30, 2023

(51) Int. Cl. B29C 64/393; B29C 64/295; B29C 64/364

(52) U.S. Cl. CPC B29C 64/393; B29C 64/295; B29C 64/364; B33Y 30/00; B33Y 50/02

(57) ABSTRACT

A system may include one or more devices. The one or more devices may obtain thermal parameters associated with a target measure of physical transformation of a four-dimensional (4D) object. The one or more devices may apply, during a printed process for the 4D object and using one or more thermal devices, air to a 4D printed material generated based on the printing process. The one or more devices may determine, using one or more camera devices, an actual measure of physical transformation of the 4D printed material resulting from applying the air to the 4D material. The one or more devices may determine whether the actual measure of physical transformation is different than the target measure of physical transformation. The one or more devices may provide an option to terminate the printing process if the actual measure of physical transformation is different than the target measure of physical transformation.

### BACKGROUND

The present invention relates to a four-dimensional (4D) printing process, and more specifically, to implementing changes in temperature during the 4D printing process. Three-dimensional (3D) printing is a process of manufacturing a 3D object from a model of the object (e.g., a computer aided design or a digital 3D model). 4D printing uses the same techniques of 3D printing. However, in 4D printing, the printed 3D object is capable of transforming after being subject to an environmental stimulus, such as heat.

### SUMMARY

A computer-implemented method comprising obtaining thermal parameters associated with a target measure of physical transformation of a four-dimensional (4D) object; selecting, based on the thermal parameters, a particular 4D material for a printing process to generate a 4D printed material for the 4D object; applying, during the printed process for the 4D object and using one or more thermal devices, air to the 4D printed material; determining, using one or more camera devices, an actual measure of physical transformation of the 4D printed material resulting from applying the air to the 4D printed material; determining that the actual measure of physical transformation is different than the target measure of physical transformation; and providing an option to terminate the printing process based on determining that the actual measure of physical transformation is different than the target measure of physical transformation.

In some implementations, a system may include one or more devices configured to: obtain thermal parameters associated with a target measure of physical transformation of a four-dimensional (4D) object; apply, during a printed process for the 4D object and using one or more thermal devices, air to a 4D printed material generated based on the printing process; determine, using one or more camera devices, an actual measure of physical transformation of the 4D printed material resulting from applying the air to the 4D printed material; determine whether the actual measure of physical transformation is different than the target measure of physical transformation; and provide an option to terminate the printing process if the actual measure of physical transformation is different than the target measure of physical transformation.

A computer program product comprising: one or more computer readable storage media, and program instructions collectively stored on the one or more computer readable storage media, the program instructions comprising: program instructions to obtain thermal parameters associated with a target measure of physical transformation of a four-dimensional (4D) object; program instructions to apply, during a printed process for the 4D object and using one or more thermal devices, air to a 4D printed material generated based on the printing process; program instructions to determine, using one or more camera devices, an actual measure of physical transformation of the 4D printed material resulting from applying the air to the 4D printed material; program instructions to determine whether the actual measure of physical transformation is different than the target measure of physical transformation; and program instructions to provide information indicating whether the actual measure of physical transformation is different than the target measure of physical transformation.

### BRIEF DESCRIPTION OF THE DRAWINGS

FIG. 1 is a diagram of an example system described herein.

FIGS. 2A-2C are diagrams of an example implementation described herein.

FIG. 3 is a diagram of an example computing environment in which systems and/or methods described herein may be implemented.

FIG. 4 is a diagram of example components of one or more devices of FIG. 1.

FIG. 5 is a flowchart of an example process associated with stimulating a physical transformation during a printing process.

### DETAILED DESCRIPTION

The following detailed description of example implementations refers to the accompanying drawings. The same reference numbers in different drawings may identify the same or similar elements.

A component of a device may be manufactured using a 3D printing process. The 3D printing process involves providing material in successive layers to create the component. The component may be an air baffle and the device may be a server or any device that utilizes an air baffle.

Currently, the air baffle is a static component which allows the air, from a fan inside the server, to flow and reduce overheating of additional components inside of the server (e.g., to cool down the additional components). In some situations, the additional components include different components that are configured to withstand different temperatures. For example, a first set of components may generate heat that exceeds heat generated by a second set of components.

Because the air baffle is a static component (e.g., non-flexible component), the air baffle is unable to undergo a transformation to allow the airflow to change direction to cool down the different components at different rates. For example, the air baffle is unable to transform to change direction to cool down the first set of components at a rate that exceeds the second set of components. The first set of components may require more airflow and/or airflow for a longer period of time than the second set of components.

As a result, the first set of components may experience damage due to the first set of components overheating. The damage may cause other components of the server and/or the server to malfunction.

Implementations described herein provide solutions to overcome the above issues relating to components that are static or inflexible. For example, implementations described herein are directed to solving a cooling issue of components when an inflexible air directing mechanism, such as an air baffle, is used for cooling the components. Additionally, implementations described herein are directed to stimulating a physical transformation of the 4D object during a printing process of the 4D object. For instance, implementations described herein are directed to monitoring an actual measure of physical transformation of the 4D object to determine whether the actual measure of physical transformation matches (or substantially matches) a target measure of physical transformation of a 4D object. A “measure of physical transformation,” as used herein, may refer to an amount by which the 4D object expands or contracts when subject to hot air (e.g., heat), cold air, hot water, and/or cold water, among other examples.

Implementations described herein utilize filaments to fabricate the 4D object by way of a 4D printing process that utilizes various factors to stimulate a response by the 4D object during the 4D printing process (e.g., various factors including hot air (or heat) and/or cold air, among other examples). For example, the filaments may be used to fabricate the air baffle. The response of the air baffle may be stimulated according to the airflow direction of a fan.

The filaments may be a 4D material. The response may indicate the actual measure of physical transformation of the 4D object. This stimulation will be executed during a printing process, of the 4D object, layer by layer to validate how much the 4D material can be expanded and/or contracted.

For example, implementations described herein are directed to a system that implements temperature changes during printing of the 4D object and that perform measurements of the 4D material during printing to confirm that the 4D material is responding to the temperature changes according to how a model of the 4D object indicates that the 4D material will react to the temperature changes. The temperature changes and the measurements may be performed layer-by-layer. The model of the 4D object may be pre-loaded into the system.

In some situations, the system may be pre-loaded with thermal parameters associated with a target measure of physical transformation. The thermal parameters may identify temperatures of components that affect the physical transformation of the 4D object during operations of the components. For example, a first component (of the components) may generate a first temperature that exceeds a second temperature generated by a second component (of the components). The components may be used in connection with the 4D object.

In some examples, the thermal parameters may be provided in the form of a thermography map of the components. In some examples, the thermal parameters may be provided in the form of heatpoints. A “heatpoint,” as used herein, may refer to information identifying a temperature generated by a component, used in connection with the 4D object, during an operation of the 4D object. The thermal parameters may be used to determine a target measure of physical transformation of the 4D object.

In some examples, the system may utilize one or more thermal devices to apply hot air and/or cold air to one or more specific surfaces (or portions) of a layer of the 4D material based on the thermal parameters. For instance, in the example of the air baffle, the thermal parameters may identify a manner in which the air baffle is to expand or contract to direct airflow to components that generate more heat than other components. The system may use the thermal parameters to analyze the expansion or the contraction of the air baffle. The analysis of the expansion or the contraction of the air baffle may be used to determine a manner in which the airflow may be redirected by the air baffle. Additionally, or alternatively, the analysis of the expansion or the contraction of the air baffle may be used to select the 4D material and the amount of the 4D material to be used.

A “thermal device,” as used herein, may include a wind tunnel and/or a laser device, among other examples. For example, the wind tunnel may be used to inject hot air and/or cold air to a specific surface of the layer of the 4D material. Additionally, or alternatively, the laser may be used to apply hot air to the specific surface. The hot air and/or the cold air may be applied to cause a response from the layer of the 4D material. The response may be a structural response in the form of expansion and/or contraction.

Additionally, the system may include one or more sensor devices to monitor the temperature of the hot air and/or the cold air and to control an operation of one or more thermal devices to control the temperature of the hot air and/or the cold air. In some examples, the sensor devices may include infrared sensor devices and/or thermal sensor devices.

The system may further include one or more camera devices that measure the actual measure of physical transformation of the 4D object. The physical transformation of the 4D object may include a change in a shape of the 4D object. For example, the one or more camera devices may measure the shape changes of the 4D object. For instance, the one or more camera devices may capture image data of the 4D object (e.g., image of the layer of the 4D material). The image data may indicate the actual measure of physical transformation of the 4D object. The actual measure of physical transformation of the 4D object may be measured in degrees, inches, feet, and/or meters, among other examples of units of measurement of expansion and contraction.

The system may determine whether the actual measure of physical transformation of the 4D object matches (e.g., within a threshold amount of deviation) the target measure of physical transformation of the 4D object. If the actual measure of physical transformation of the 4D object does not correspond to the target measure of physical transformation of the 4D object, the system may automatically terminate and/or provide an option to terminate the printing process (e.g., to select a different 4D material that may better correspond to the target measure of physical transformation).

By stimulating a response by the 4D object as described herein, implementations described herein may prevent the 4D object from being fabricated in a manner that may cause damage to and/or malfunction of components used in conjunction with the 4D object. By stimulating a response by the 4D object as described herein, implementations described herein may preserve computing resources that would have been used to re-fabricate the 4D object and/or the components.

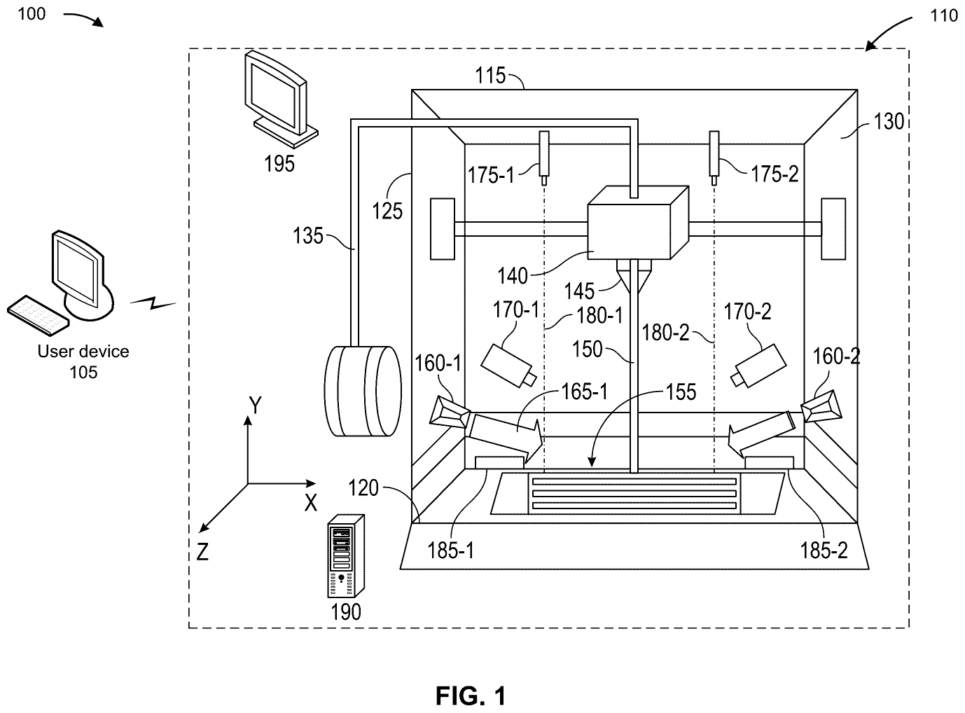

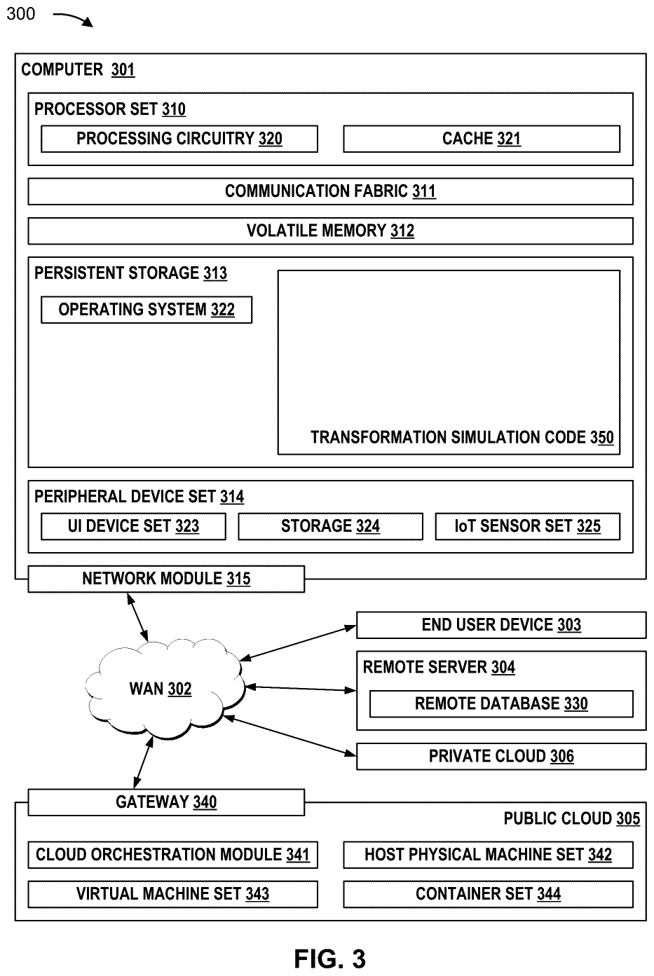

FIG. 1 is a diagram of an example system 100 described herein. As shown in FIG. 1, example system 100 includes a user device 105 and a 4D printer 110. These devices are described in more detail below in connection with FIG. 3.

User device 105 and 4D printer may be connected via wired connections, wireless connections, or a combination of wired and wireless connections. The devices may be connected via a network that includes one or more wired and/or wireless networks. For example, the network may include Ethernet switches. Additionally, or alternatively, the network may include a cellular network, a public land mobile network (PLMN), a local area network (LAN), a wide area network (WAN), a private network, the Internet, and/or a combination of these or other types of networks. The network enables communication between user device 105, 4D printer 110, and/or one or more additional devices associated with 4D printer 110.

User device 105 may include one or more devices configured to receive, generate, store, process, and/or provide information associated with a 4D printing process, as explained herein. User device 105 may be used to provide printing information that may be used to fabricate a 4D object.

User device 105 may include a communication device and a computing device. For example, user device 105 may include a wireless communication device, a mobile phone, a user equipment, a laptop computer, a tablet computer, a desktop computer, and/or a similar type of device.

4D printer 110 may include one or more devices configured to receive, generate, store, process, and/or provide information associated with printing the 4D object, as explained herein. For example, 4D printer 110 may be configured to fabricate the 4D object by way of a 4D printing process. Additionally, or alternatively, 4D printer 110 may be configured to provide information regarding an actual measure of physical transformation of the 4D object during the 4D printing process. Additionally, or alternatively, 4D printer 110 may be configured to provide an option to terminate the printing process if the actual measure of physical transformation of the 4D object does not match a target measure of physical transformation of the 4D object.

As shown in FIG. 1, 4D printer 110 includes a top portion 115, a bottom portion 120 opposite top portion 115, a first lateral portion 125, and a second lateral portion 130 opposite first lateral portion 125. Bottom portion 120 may include a print bed.

As shown in FIG. 1, 4D printer 110 further includes a filament 135 on a filament spool, an extruder assembly that includes a cold end 140 and a hot end 145. Filament 135 may be a 4D material, such as hydro-reactive polymers, cellulose composites, thermos-reactive polymers, among other examples. Cold end 140 may be configured to receive and pull filament 135. Hot end 145 may be configured to increase the temperature of filament 135 and to dispense a 4D printed material 150. Hot end 145 may be configured to dispense multiple layers 155, of 4D printed material 150, on the print bed of bottom portion 120.

As shown in FIG. 1, 4D printer 110 may include a first wind generating device 160-1, a second wind generating device 160-2, and so on (collectively “wind generating devices 160”). First wind generating device 160-1 may include one or more devices configured to generate air to stimulate airflow during the printing process of each layer 155 of 4D printed material. As an example, first wind generating device 160-1 may include a wind tunnel, a fan, among other examples of devices that generate air. The air may include hot air (e.g., heat) and/or cold air. First wind generating device 160-1 may generate the air to cause a physical transformation of 4D printed material. The temperature of the air may be based on operating temperatures of components used in conjunction with the 4D object. For example, in the context of the 4D object being an air baffle used on a printed circuit board with a central processing unit, the range of temperatures may be from a value of approximately +20° Celsius up to a value of approximately +102.0° Celsius. Accordingly, the hot air may be in the range of approximately 80° Celsius to approximately 102.0° Celsius and the cold air may be in the range of approximately 10° Celsius to approximately 20.0° Celsius.

As another example, in the context of the 4D object being an air baffle used on a printed circuit board with a memory device, the range of temperatures may be from a value of approximately +20° Celsius up to a value of approximately +100.0° Celsius. Accordingly, the hot air may be in the range of approximately 80° Celsius to approximately 100.0° Celsius and the cold air may be in the range of approximately 10° Celsius to approximately 20.0° Celsius. In some instances, the hot air may be in the range of approximately 80° Celsius to approximately 110° Celsius and the cold air may be in the range of approximately 0° Celsius to approximately 20° Celsius.

In some implementations, first wind generating device 160-1 may be positioned on the x-axis of 4D printer 110. For example, first wind generating device 160-1 may be moveably coupled to mechanical components that allow first wind generating device 160-1 to move along the x-axis of 4D printer 110. The mechanical components elements may include tracks or rails along the x-axis of 4D printer 110. In some examples, the mechanical components may be provided between first lateral portion 125 and second lateral portion 130. In this regard, the airflow may be between first lateral portion 125 and second lateral portion 130. As shown in FIG. 1, first wind generating device 160-1 may generate an airflow 165-1.

Additionally, or alternatively, the mechanical components may be provided between a front portion of 4D printer 110 and a rear portion of 4D printer 110 (opposite the front portion). In this regard, the mechanical components may allow first wind generating device 160-1 to move along the y-axis of 4D printer 110. Accordingly, the airflow may be between the front portion of 4D printer 110 and the rear portion of 4D printer 110. The description of first wind generating device 160-1 is applicable to second wind generating device 160-2.

As shown in FIG. 1, 4D printer 110 may include a first camera device 170-1, a second camera device 170-2, and so on (collectively “camera devices 170”). First camera device 170-1 may include one or more devices capable of capturing image data of each layer 155 during the printing process. The image data may be used to determine an actual measure of physical transformation of the 4D printed material 150 of the layer 155.

In some examples, first camera device 170-1 may be a monocular camera. Alternatively, first camera device 170-1 may be a stereo camera. The description of first camera device 170-1 is applicable to second camera device 170-2.

As shown in FIG. 1, 4D printer 110 may include a first laser device 175-1, a second laser device 175-2, and so on (collectively “laser devices 175”). First laser device 175-1 may include one or more devices capable of generating hot air during the printing process. For example, first laser device 175-1 may be configured to irradiate a portion of the 4D printer material 150, thereby increasing the temperature of the portion of the 4D printer 110.

As shown in FIG. 1, first laser device 175-1 may generate a light beam 180-1 that irradiates a portion of a layer 155, of the 4D printer material 150, to increase the temperature of the portion of the layer 155. First laser device 175-1 may irradiate the top portion of the layer 155 of 4D printed material 150 to cause a physical transformation of 4D printed material 150.

In some implementations, first laser device 175-1 may be positioned on the y-axis of 4D printer 110. For example, first laser device 175-1 may be moveably coupled to mechanical components that allow first laser device 175-1 to move along the y-axis of 4D printer 110. The mechanical components elements may include tracks or rails along the y-axis of 4D printer 110. The description of first laser device 175-1 is applicable to second laser device 175-2.

As shown in FIG. 1, 4D printer 110 may include a first sensor device 185-1, a second sensor device 185-2, and so on (collectively “sensor devices 185”). First sensor device 185-1 may include one or more devices capable of sensing the temperature of the airflow generated by one or more wind generating devices 160 and/or the temperatures of the light beams generated by one or more laser devices 175.

In some implementations, first sensor device 185-1 may generate temperature data indicating the temperature of the airflow and/or the temperatures of the light beams. The temperature data may be used to control the operations of the one or more wind generating devices 160 and/or the one or more laser devices 175. For example, the temperature data may be used to cause the one or more wind generating devices 160 and/or the one or more laser devices 175 to increase the temperature of the airflow and/or temperatures of the light beams. Additionally, or alternatively, the temperature data may be used to cause the one or more wind generating devices 160 and/or by the one or more laser devices 175 to decrease the temperature of the airflow and/or the temperatures of the light beams.

Controller 190 (e.g., an electronic control module (ECM)) may include one or more devices configured to control and/or monitor operations of 4D printer 110. For example, controller 190 may control and/or monitor the operations of wind the one or more generating devices 160, the one or more laser devices 175, and/or other components of 4D printer 110 based on signals from camera devices 170 and/or sensor devices 185. Additionally, or alternatively, controller 190 may control and/or monitor the operations based on information regarding a target measure of physical transformation of 4D printed material 150. Controller 190 may control and/or monitor the operations to stimulate a response by the 4D printed material 150 based on temperature changes during the printing process of the 4D object.

In some implementations, controller 190 may configured to control locations of the one or more wind generating devices 160 and/or of the one or more laser devices 175, control orientations of the one or more wind generating devices 160 and/or of the one or more laser devices 175, control the temperature of the airflow, control the temperatures of the light beams, among other examples of operations of 4D printer 110 that may be controlled to implement temperature changes during the printing process of the 4D object.

By implementing the temperature changes during the printing process of the 4D object as described herein, implementations described herein may prevent the fabrication of a component that may cause damage to and/or malfunction of components used in conjunction with the 4D object. By implementing the temperature changes during the printing process of the 4D object as described herein, implementations described herein may preserve computing resources that would have been used to re-fabricate the 4D object and/or the components.

As shown in FIG. 1, 4D printer 110 may include a display device 195. Display device 195 may include one or more devices configured to display progress information regarding the progress of the printing process of the 4D object. In some examples, the progress information may indicate whether the actual measure of physical transformation of 4D printed material 150 is different than the target measure of physical transformation of 4D printed material 150. In some implementations, controller 190 and/or display device 195 may be included in user device 105.

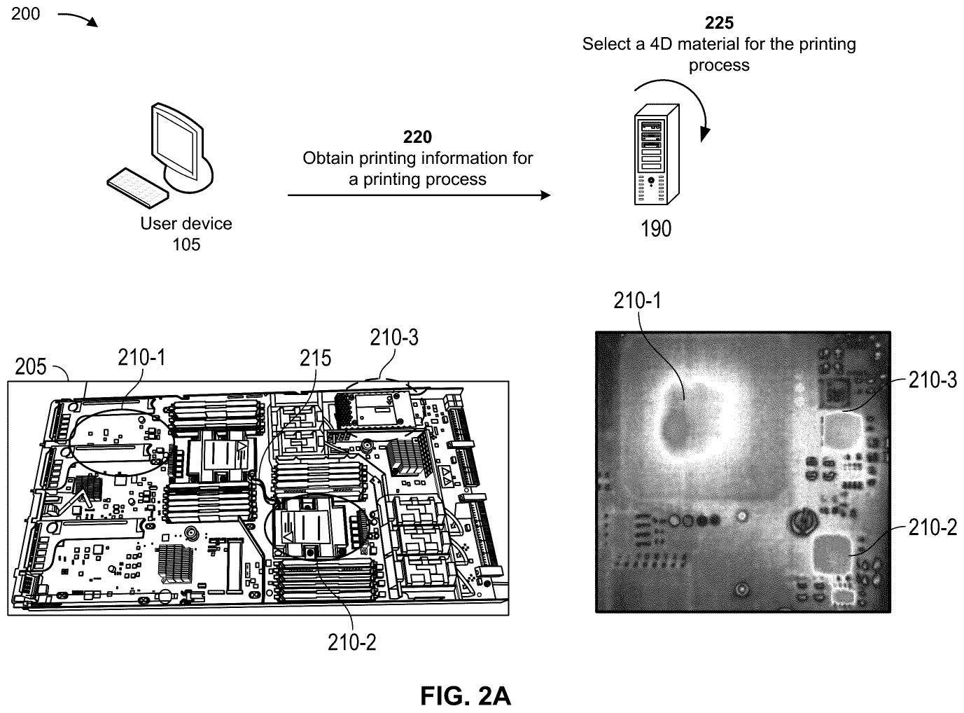

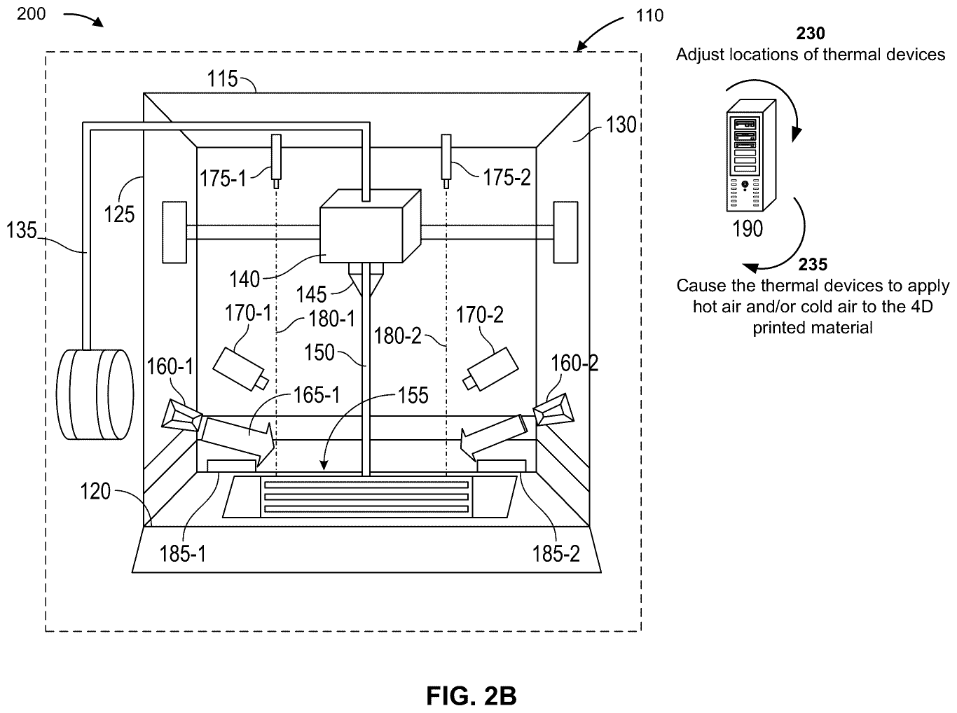

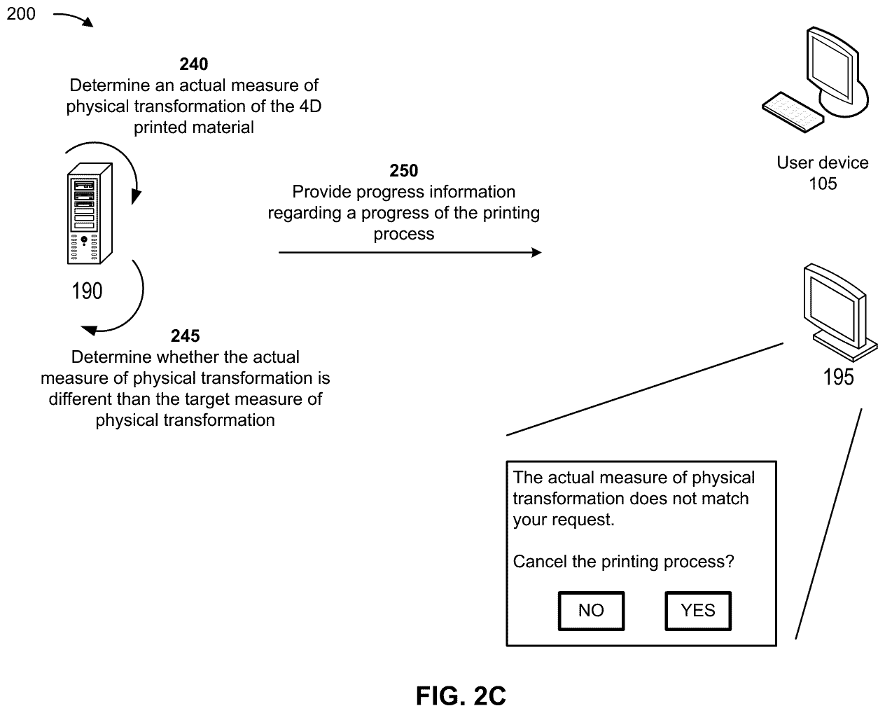

As indicated above, FIG. 1 is provided as an example. Other examples may differ from what is described with regard to FIG. 1. The number and arrangement of devices shown in FIG. 1 are provided as an example. A network, formed by the devices shown in FIGS. 2A-2C may be part of a network that comprises various configurations and uses various protocols including local Ethernet networks, private networks using communication protocols proprietary to one or more companies, cellular and wireless networks (e.g., Wi-Fi), instant messaging, Hypertext Transfer Protocol (HTTP) and simple mail transfer protocol (SMTP), and various combinations of the foregoing.

There may be additional devices (e.g., a large number of devices), fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

FIGS. 2A-2C are diagrams of an example implementation 200 described herein. As shown in FIGS. 2A-2C, example implementation 200 includes user device 105 and 4D printer 110. In the example herein, 4D printer 110 may be used to print the 4D object. The 4D object may be an air baffle used, on a printed circuit board, to direct airflow of air from a fan. The airflow may be used to cool other components of the printed circuit board.

4D printer 110 may be configured to print the air baffle such that the air baffle is configured to transform based on heat generating by components of the printed circuit board and/or based on the air from the fan. For example, the air baffle may be configured to adjust a direction of the airflow to cool a first component over a second component based on the first component generating more heat than the second component.

As shown in FIG. 2A, and by reference number 220, controller 190 may obtain printing information for a printing process. In some implementations, controller 190 may obtain the printing information from user device 105. For example, user device 105 may provide the printing information as part of a request to print the 4D object.

In some implementations, the printing information may include information regarding a 3D model of the 4D object. As an example, the printing information may include a 3D model of an object that includes the 4D object. In the example herein, as shown in FIG. 1A, the 3D model may be a 3D model of a printed circuit board 205 that includes an air baffle 215.

In some examples, the 3D model may be provided in the form of a computer aided drawing. The 3D model may identify a first heatpoint 210-1, a second heatpoint 210-2, a third heatpoint 210-3, and so on (collectively heatpoints 210). In some implementations, heatpoints 210 may be provided with graphical information indicating temperatures generated by components associated with heatpoints 210.

For example, first heatpoint 210-1 and second heatpoint 210-2 may be provided with a first color and third heatpoint 210-3 may be provided with a second color. The first color may indicate a first temperature and the second color may indicate a second temperature. First heatpoint 210-1 may indicate that a first component is generating the first temperature, second heatpoint 210-2 may indicate that a second component is generating the first temperature, a third heatpoint 210-3 may indicate that a third component is generating the second temperature. The first color and the second color may indicate that the first temperature exceeds the second temperature.

In some implementations, the printing information may include a thermography image of printed circuit board 205. As shown in FIG. 2A, the thermography image may identify heatpoints 210. Printing information includes airflow information regarding an airflow of air from a fan of printed circuit board 205 and may include heatpoint information identifying heatpoints 210. The airflow information may identify a direction of the airflow and a temperature of the airflow.

The heatpoint information may identify temperatures of heatpoints 210 and locations of heatpoints 210 on printed circuit board 205. For example, the heatpoint information may identify the first temperature, the second temperature, and so on on. Additionally, or alternatively, the heatpoint information may identify the location of first heatpoint 210-1 with respect to air baffle 215, identify the location of second heatpoint 210-2 with respect to air baffle 215, and so on.

Printing information includes transformation information identifying a target measure of transformation of the 4D printed material. A target measure of physical transformation may indicate a target amount by which the 4D object is to expand or contract when subject to hot air (e.g., heat), cold air, water, among other examples. The target amount may be identified in degrees, in meters, in inches, among other examples of measuring units.

In some implementations, the target measure of physical transformation may be determined based on an observed behavior of an object similar to the 4D object. For instance, with respect to the example of the air baffle, the operation of printed circuit board 205 may be monitored. For example, the temperatures of the components, of printed circuit board 205, may be monitored. The temperatures may indicate a direction of the airflow to cool down the components. The direction of the airflow may be used to determine the target measure of physical transformation of the air baffle that would cause the air baffle to change the direction of the airflow to cool the components.

As shown in FIG. 2A, and by reference number 225, controller 190 may select the 4D material for the printing process. In some implementations, controller 190 may select the 4D material based on the target measure of physical transformation. For example, controller 190 may select the 4D material as a material that is configured to expand and/or contract in a manner indicated by the target measure of physical transformation.

In some implementations, the printing information may include information identifying the 4D material and/or information identifying a type of material. In this regard, controller 190 may select the 4D material using the information identifying the 4D material and/or the information identifying the type of material.

As shown in FIG. 2B, and by reference number 230, controller 190 may adjust locations of the thermal devices. As explained herein, the printing information may identify locations of heatpoints 210. Accordingly, controller 190 may identify the locations of heatpoints 210 based on the printing information. Based on the locations of heatpoints 210, controller 190 may adjust the locations of the thermal devices.

For example, controller 190 may use the locations of heatpoints 210 to position the thermal devices at locations that will cause the thermal devices to generate heat at target locations on the print bed corresponding to the locations of heatpoints 210. For instance, controller 190 may use the locations of heatpoints 210 to position one or more wind generating devices 160 apply heat to the target locations. Additionally, or alternatively, controller 190 may use the locations of heatpoints 210 to position one or more laser devices 175 to apply heat to the target locations. In some situations, the target locations may be specific portions of 4D printed material 150 (e.g., specific portions of a layer 155).

As explained herein, the printing information may identify a direction of airflow. In some situations, the direction of the airflow may be based on observed airflow generated by the fan of printed circuit board 205 during the operation of printed circuit board 205. In some implementations, controller 190 may use the direction of the airflow to position the one or more wind generating devices 160 at locations that will cause the one or more wind generating devices 160 to generate airflow towards the target locations on the print bed.

As shown in FIG. 2B, by reference number 235, controller 190 may cause the thermal devices to apply hot air and/or cold air to the 4D printed material. For example, controller 190 may cause the thermal devices to apply the hot air and/or the cold air to a layer 155 of 4D printed material 150. Controller 190 may cause the thermal devices to apply the hot air and/or the cold air to stimulate a response from 4D printed material 150 (e.g., to cause a physical transformation of 4D printed material 150). As explained herein, the heatflow information (of the printing information) may identify the temperatures of heatpoints 210. Accordingly, controller 190 may use the heatflow information to determine the temperatures of heatpoints 210.

Controller 190 may cause the thermal devices to generate the hot air (or heat) in accordance with the temperatures of heatpoints 210. For example, controller 190 may cause a first thermal device generate the hot air with a temperature equal to (or approximately equal to) to the temperature of first heatpoint 210-1, cause a second thermal device generate the hot air with a temperature equal to (or approximately equal to) to the temperature of second heatpoint 210-2, and so on. The first thermal device may be positioned based on the location of first heatpoint 210-1, the second thermal device may be positioned based on the location of second heatpoint 210-2, and so on.

In some examples, the thermal devices may generate the hot air in accordance with the temperatures of heatpoints 210. For example, the temperature of the hot air (generated one or more wind generating devices 160. In some examples, the thermal devices may generate light beams in accordance with the temperatures of heatpoints 210. For example, the temperatures of the light beams may be the temperatures of heatpoints 210.

As explained herein, the airflow information (of the printing information) may identify the direction of the airflow and the temperature of the airflow. Accordingly, controller 190 may use the airflow information to determine the temperature of the airflow generated by the thermal devices. Controller 190 may cause the thermal devices to generate the cold air in accordance with the temperature of the airflow identified by the airflow information.

Controller 190 may cause the thermal devices to generate the airflow between first lateral portion 125 and second lateral portion 130. Additionally, or alternatively, controller 190 may cause the thermal devices to generate the airflow between the front portion of 4D printer 110 and the rear portion of 4D printer 110.

In some implementations, sensor devices 185 may monitor and measure the temperature of the airflow and/or may monitor and measure the temperatures of the light beams. For example, sensor devices 185 may generate the temperature data indicating the temperature of the airflow and/or the temperatures of the light beams (herein after “measured temperatures”). Sensor devices 185 may provide the temperature data to controller 190. Controller 190 may compare the measured temperature of the airflow and the measure temperature of the airflow identified in the airflow information.

Based on comparing, controller 190 may adjust the measured temperature (e.g., controller 190 may cause the thermal devices to adjust the temperatures of the air generated by the thermal devices). For example, controller 190 may increase the measured temperature if the temperature of the airflow (identified in the airflow information) exceeds the measured temperature. Conversely, controller 190 may decrease the measured temperature if the measured temperature exceeds the temperature of the airflow (identified in the airflow information). Controller 190 may adjust the measure temperatures of the light beams in a similar manner.

As shown in FIG. 2C, and by reference number 240, controller 190 may determine an actual measure of physical transformation of the 4D printed material. In some implementations, controller 190 may determine the actual measure of physical transformation of 4D printed material 150 based on the image data generated by camera devices 170. For example, camera devices 170 may capture one or more images of the layer 155 of 4D printed material 150 and may generate the image data based on capturing the one or more images.

The one or more images may depict the actual measure of physical transformation of 4D printed material 150. For example, the one or more images may depict the physical transformation of 4D printed material 150 as a result of the hot air and/or the cold air being applied to 4D printed material 150. The one or more images may be analyzed to determine the physical transformation of 4D printed material 150. For example, the one or more images may be analyzed to determine the actual measure of physical transformation of 4D printed material 150.

As shown in FIG. 2C, and by reference number 240, controller 190 may determine whether the actual measure of physical transformation is different than the target measure of physical transformation. For example, controller 190 may compare the actual measure of physical transformation and the target measure of physical transformation to determine whether the actual measure of physical transformation is different than the target measure of physical transformation. Based on comparing the actual measure of physical transformation is different than the target measure of physical transformation, controller 190 may determine whether the actual measure of physical transformation is different than the target measure of physical transformation.

As shown in FIG. 2C, and by reference number 245, controller 190 may provide progress information regarding the printing process. In some implementations, as the printing process progresses, controller 190 may provide the progress information indicating the progress of the printing process. For example, the progress information may indicate a quantity of layers 155 printed, an amount of time remaining until the printing process is complete, and/or a current depiction of the 4D printed object, among other examples.

In some implementations, the progress information may indicate whether the actual measure of physical transformation is different than the target measure of physical transformation. For example, if the actual measure of physical transformation is different than the target measure of physical transformation, the progress information may provide an option to terminate the printing operation, select a new 4D printing material, and start a new printing process with the new 4D printing material. Additionally, or alternatively, if the actual measure of physical transformation is different than the target measure of physical transformation, controller 190 may automatically terminate the printing process and/or automatically select the new 4D printing material.

By stimulating a response by the 4D object as described herein, implementations described herein may prevent the 4D object from being fabricated in a manner that may cause damage to and/or malfunction of components used in conjunction with the 4D object. By stimulating a response by the 4D object as described herein, implementations described herein may preserve computing resources that would have been used to re-fabricate the 4D object and/or the components.

As indicated above, FIGS. 2A-2C are provided as an example. Other examples may differ from what is described with regard to FIGS. 2A-2C. The number and arrangement of devices shown in FIGS. 2A-2C are provided as an example. A network, formed by the devices shown in FIGS. 2A-2C may be part of a network that comprises various configurations and uses various protocols including local Ethernet networks, private networks using communication protocols proprietary to one or more companies, cellular and wireless networks (e.g., Wi-Fi), instant messaging, Hypertext Transfer Protocol (HTTP) and simple mail transfer protocol (SMTP), and various combinations of the foregoing.

There may be additional devices (e.g., a large number of devices), fewer devices, different devices, or differently arranged devices than those shown in FIGS. 2A-2C. Furthermore, two or more devices shown in FIGS. 2A-2C may be implemented within a single device, or a single device shown in FIGS. 2A-2C may be implemented as multiple, distributed devices. Additionally, or alternatively, a set of devices (e.g., one or more devices) shown in FIGS. 2A-2C may perform one or more functions described as being performed by another set of devices shown in FIGS. 2A-2C.

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code involved in performing the inventive methods, such as transformation simulation code 350. In addition to block 350, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 350, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 350 in persistent storage 313.

COMMUNICATION FABRIC 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in block 350 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

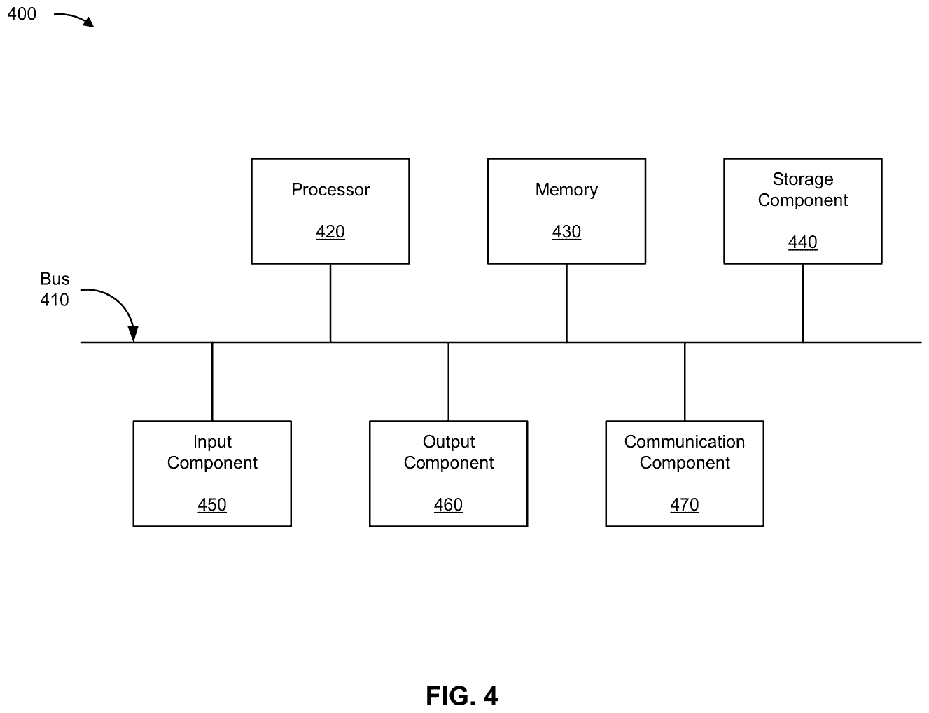

FIG. 4 is a diagram of example components of a device 400, which may correspond to user device 105 and/or 4D printer 110. In some implementations, user device 105 and/or 4D printer 110 may include one or more devices 400 and/or one or more components of device 400. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may be a repository that stores a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

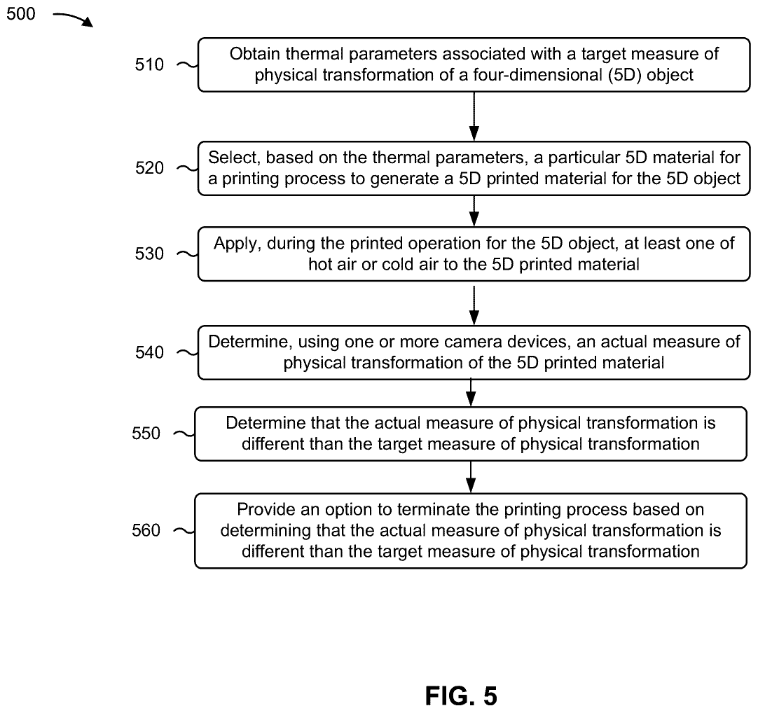

FIG. 5 is a flowchart of an example process 500 associated with stimulating a physical transformation during a printing process. In some implementations, one or more process blocks of FIG. 5 may be performed by a 4D printer (e.g., 4D printer 110). In some implementations, one or more process blocks of FIG. 5 may be performed by another device or a group of devices separate from or including the 4D printer, such as a user device (e.g., user device 105). Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include obtaining thermal parameters associated with a target measure of physical transformation of a four-dimensional (4D) object (block 510). For example, the 4D printer may obtain thermal parameters associated with a target measure of physical transformation of a four-dimensional (4D) object, as described above.

As further shown in FIG. 5, process 500 may include selecting, based on the thermal parameters, a particular 5D material for a printing process to generate a 4D printed material for the 4D object (block 520). For example, the 4D printer may select, based on the thermal parameters, a particular 4D material for a printing process to generate a 4D printed material for the 4D object, as described above.

As further shown in FIG. 5, process 500 may include applying, during the printed process for the 4D object and using one or more thermal devices, at least one of hot air or cold air to the 4D printed material (block 530). For example, the 4D printer may determine, using one or more camera devices, an actual measure of physical transformation of the 4D printed material resulting from applying at the least one of hot air or cold air to the 4D printed material, as described above.

As further shown in FIG. 5, process 500 may include determining, using one or more camera devices, an actual measure of physical transformation of the 4D printed material resulting from applying at the least one of hot air or cold air to the 4D printed material (block 540). For example, the 4D printer may determine, using one or more camera devices, an actual measure of physical transformation of the 4D printed material resulting from applying at the least one of hot air or cold air to the 4D printed material, as described above.

As further shown in FIG. 5, process 500 may include determining that the actual measure of physical transformation is different than the target measure of physical transformation (block 550). For example, the 4D printer may apply the generated test cases to the source programming language and to the target programming language, as described above.

As further shown in FIG. 5, process 500 may include providing an option to terminate the printing process based on determining that the actual measure of physical transformation is different than the target measure of physical transformation (block 560). For example, the 4D printer may provide an option to terminate the printing process based on determining that the actual measure of physical transformation is different than the target measure of physical transformation, as described above.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method comprising:
obtaining thermal parameters associated with a target measure of physical transformation of a four-dimensional (4D) object;
selecting, based on the thermal parameters, a particular 4D material for a printing process to generate a 4D printed material for the 4D object;
applying, during the printed process for the 4D object and using one or more thermal devices, air to the 4D printed material;
determining, using one or more camera devices, an actual measure of physical transformation of the 4D printed material resulting from applying the air to the 4D printed material;
determining that the actual measure of physical transformation is different than the target measure of physical transformation; and
providing an option to terminate the printing process based on determining that the actual measure of physical transformation is different than the target measure of physical transformation.

2. The computer-implemented method of claim 1, wherein the thermal parameters identify different respective temperatures for different portions of the 4D object, and
wherein obtaining the thermal parameters comprises at least one of:
obtaining a thermography image of the 4D object; or
obtaining heatpoints of the 4D object.

3. The computer-implemented method of claim 1, wherein determining whether the actual measure of physical transformation is different than the target measure of physical transformation comprises:
determining whether the actual measure of physical transformation is different than the target measure of physical transformation during printing of each layer of the 4D printed material.

4. The computer-implemented method of claim 1, wherein applying the air to the 4D printed material comprises:
applying at least one hot air or cold air using one or more wind generating devices.

5. The computer-implemented method of claim 4, wherein the thermal parameters identify different temperatures for different portions of the 4D object, and
wherein applying the at least one of the hot air or the cold air comprises:
determining a particular direction of airflow based on the different temperatures for the different portions of the 4D object; and
applying the at least one of the hot air or the cold air to stimulate the airflow in the particular direction.

6. The computer-implemented method of claim 1, wherein applying the air to the 4D printed material comprises:
applying hot air using one or more laser devices.

7. The computer-implemented method of claim 6, wherein the thermal parameters identify different temperatures for different portions of the 4D object, and
wherein applying the at least one of the hot air or the cold air comprises:
determining a particular portion of the 4D printed material based the different temperatures for the different portions of the 4D object; and
applying the hot air, using the one or more laser devices, to the particular portion of the 4D printed material.

8. The computer-implemented method of claim 1, further comprising:
determining, using one or more sensor devices, a temperature of the at least one of the hot air or the cold air; and
adjusting an operation of the one or more thermal devices based on the thermal parameters and based on determining the temperature of the at least one of the hot air or the cold air.

9. A system comprising:
one or more devices configured to:
obtain thermal parameters associated with a target measure of physical transformation of a four-dimensional (4D) object;
apply, during a printed process for the 4D object and using one or more thermal devices, air to a 4D printed material generated based on the printing process;
determine, using one or more camera devices, an actual measure of physical transformation of the 4D printed material resulting from applying the air to the 4D printed material;
determine whether the actual measure of physical transformation is different than the target measure of physical transformation; and
provide an option to terminate the printing process if the actual measure of physical transformation is different than the target measure of physical transformation.

10. The system of claim 9, wherein the one or more devices are further configured to:
select, based on the thermal parameters, a particular 4D material for the printing process to generate the 4D printed material.

11. The system of claim 10, wherein the one or more devices are further configured to:
determine that the actual measure of physical transformation is different than the target measure of physical transformation; and
select another particular 4D material for the printing process based on determining that the actual measure of physical transformation is different than the target measure of physical transformation.

12. The system of claim 9, wherein the one or more devices are further configured to:
determine, using one or more sensor devices, a temperature of the at least one of the hot air or the cold air; and
adjust an operation of the one or more thermal devices to adjust the temperature,
wherein the operation of the one or more thermal is adjusted based on the thermal parameters and the temperature of the at least one of the hot air or the cold air.

13. The system of claim 9, wherein, to apply the air to the 4D printed, the one or more devices are further configured to:
apply at least one hot air or cold air using one or more wind generating devices.

14. The system of claim 9, wherein, to apply the at least one of the hot air or the cold air to the 4D printed, the one or more devices are further configured to:
determine a particular direction of airflow based on the thermal parameters; and
apply the at least one of the hot air or the cold air to stimulate the airflow in the particular direction.

15. A computer program product comprising:
one or more computer readable storage media, and program instructions collectively stored on the one or more computer readable storage media, the program instructions comprising:
program instructions to obtain thermal parameters associated with a target measure of physical transformation of a four-dimensional (4D) object;
program instructions to apply, during a printed process for the 4D object and using one or more thermal devices, air to a 4D printed material generated based on the printing process;
program instructions to determine, using one or more camera devices, an actual measure of physical transformation of the 4D printed material resulting from applying the air to the 4D printed material;
program instructions to determine whether the actual measure of physical transformation is different than the target measure of physical transformation; and
program instructions to provide information indicating whether the actual measure of physical transformation is different than the target measure of physical transformation.

16. The computer program product of claim 15, wherein the program instructions further comprise:
program instructions to provide an option to terminate the printing process if the actual measure of physical transformation is different than the target measure of physical transformation.

17. The computer program product of claim 15, wherein the program instructions to obtain the thermal parameters comprise:
program instructions to obtain a thermography image, of the 4D object, that identify different temperatures for different portions of the 4D object; or
program instructions to obtain heatpoints, of the 4D object, that identify different temperatures for different portions of the 4D object.

18. The computer program product of claim 17, wherein the program instructions to apply the air comprise:
program instructions to determine a particular direction of airflow based on the different temperatures for the different portions of the 4D object; and
program instructions to apply the air to stimulate the airflow in the particular direction.

19. The computer program product of claim 17, wherein the program instructions to apply the air comprise:
program instructions to determine a particular portion of the 4D printed material based the different temperatures for the different portions of the 4D object; and
program instructions to apply hot air, using one or more laser devices, to the particular portion of the 4D printed material.

20. The computer program product of claim 15, wherein the program instructions to further comprise:
program instructions to select, based on the thermal parameters, a particular 4D material for the printing process to generate the 4D printed material;
program instructions to determine that the actual measure of physical transformation is different than the target measure of physical transformation; and
program instructions to select another particular 4D material for the printing process based on determining that the actual measure of physical transformation is different than the target measure of physical transformation.
